(19) United States
(12) Patent Application Publication
(10) Pub. No.: US 2015/0146071 A1
(43) Pub. Date: May 28, 2015

(54) MOBILE TERMINAL AND METHOD FOR CONTROLLING THE SAME

(71) Applicant: LG ELECTRONICS INC., Seoul (KR)

(72) Inventor: Jinsung YI, Seoul (KR)

(73) Assignee: LG ELECTRONICS INC.

(21) Appl. No.: 14/303,420

(22) Filed: Jun. 12, 2014

(30) Foreign Application Priority Data
Nov. 22, 2013 (KR) 10-2013-0142824

(51) Int. Cl. H04N 5/232; H04N 5/44; G06K 9/00

(52) U.S. Cl. CPC H04N 5/23293; G06K 9/00288; H04N 5/44
USPC 348/333.02

(57) ABSTRACT

There is disclosed a method for controlling a mobile terminal including implementing a camera application, displaying a preview image, requesting first information related with a person contained in the preview image from an external device, receiving the first information from the external device, and displaying the first information on the displayed preview image.

Pursuant to 35 U.S.C. § 119(a), this application claims the benefit of earlier filing date and right of priority to Korean Application No.10-2013-0142824, filed on Nov. 22, 2013, the contents of which are hereby incorporated by reference herein in their entirety.

### BACKGROUND OF THE DISCLOSURE

1. Field of the Disclosure

Embodiments of the present disclosure relates to a mobile terminal and a method for controlling the same, which has improved usability to realize terminal usage.

2. Discussion of the Related Art

A mobile terminal is a device which may be configured to perform various functions. Examples of such functions include data and voice communications, capturing images and video via a camera, recording audio, playing music files and outputting music via a speaker system, and displaying images and video on a display. Some terminals include additional functionality which supports game playing, while other terminals are also configured as multimedia players. More recently, mobile terminals have been configured to receive broadcast and multicast signals which permit viewing of contents, such as videos and television programs.

Generally, terminals can be classified into mobile terminals and stationary terminals according to a presence or non-presence of mobility. And, the mobile terminals can be further classified into handheld terminals and vehicle mount terminals according to availability for hand-carry.

There are ongoing efforts to support and increase the functionality of mobile terminals. Such efforts include software and hardware improvements, as well as changes and improvements in the structural components which form the mobile terminal

In recent, technology for capturing a photograph, using a camera mounted in a mobile terminal, and for editing the captured photograph is being widely used. However, such camera-related functions are provided mainly for pictures of people and there are a few functions which can be shared by a person capturing a picture and a person as an object of the picture.

### SUMMARY OF THE DISCLOSURE

An object of the present disclosure is to provide a mobile terminal which provides a fun function through communication between a person capturing a picture and a person.

Another object of the present disclosure is to provide a mobile terminal which may composes person-related information sent from an external device with an image acquired through a camera.

To achieve these objects and other advantages and in accordance with the purpose of the disclosure, as embodied and broadly described herein, a method for controlling a mobile terminal includes implementing a camera application; displaying a preview image; requesting first information related with a person contained in the preview image from an external device; receiving the first information from the external device; and displaying the first information on the displayed preview image.

In another aspect, a method for controlling a mobile terminal includes implementing a camera application; displaying a preview image; implementing face recognition for a person contained in the preview image; extracting information related with the recognized person from a memory; and displaying the extracted information on the displayed preview image.

In a further aspect, a mobile terminal includes a camera; a display configured to display a preview image acquired by the camera; a wireless communication unit communicable with an external device wirelessly; and a controller, wherein the controller requests first information related with information contained in the preview image from the external device and controls the wireless communication unit to receive the first information from the external device, and the controller controls the display to display the received first information on the displayed preview image.

It is to be understood that both the foregoing general description and the following detailed description of the preferred embodiments of the present invention are exemplary and explanatory and are intended to provide further explanation of the invention as claimed.

### BRIEF DESCRIPTION OF THE DRAWINGS

The above and other aspects, features, and advantages of the present invention will become more apparent upon consideration of the following description of preferred embodiments, taken in conjunction with the accompanying drawing figures.

FIG. 1 is a block diagram of a mobile terminal according to one embodiment of the disclosure;

FIG. 2a is a front perspective view of a mobile terminal or hand-held device;

FIG. 2b is a rear perspective view of the mobile terminal shown in FIG. 2a;

FIGS. 3, 4, 5, 6 and 7 are diagrams illustrating examples of configuration screens displayed on a display of a mobile terminal according to one embodiment of the disclosure;

FIG. 8 is a flow chart illustrating an example of a method for sharing information between a first mobile terminal and a second mobile terminal according to one embodiment of the disclosure;

FIG. 9 is a diagram illustrating an example of a screen displayed on a display of a mobile terminal according to one embodiment of the disclosure;

FIG. 10 is a diagram illustrating another example of a screen displayed on a display of a mobile terminal according to one embodiment of the disclosure;

FIG. 11 is a diagram illustrating an example of a screen displayed on a display of a mobile terminal according to another embodiment of the disclosure;

FIG. 12 is a diagram illustrating an example of a screen displayed on a display of a mobile terminal according to one embodiment of the disclosure;

FIG. 13 is a diagram illustrating another example of a screen on a display of a mobile terminal according to one embodiment of the disclosure;

FIG. 14 is a diagram to describe an example of a method for editing first information displayed on a display of a mobile terminal according to one embodiment of the disclosure;

FIG. 15 is a flow chart to describe an example of a method for using the information stored in a memory, instead of the information received by a mobile terminal according to one embodiment of the disclosure from an external device; and

FIGS. 16, 17, 18, 19 and 20 are diagrams illustrating examples of a screen displayed on a display of a mobile terminal according to one embodiment of the disclosure.

### DESCRIPTION OF SPECIFIC EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

As used herein, the suffixes ‘module’, ‘unit’ and ‘part’ are used for elements in order to facilitate the disclosure only. Therefore, significant meanings or roles are not given to the suffixes themselves and it is understood that the ‘module’, ‘unit’ and ‘part’ can be used together or interchangeably.

The present invention can be applicable to a various types of terminals. Examples of such terminals include mobile terminals, such as mobile phones, user equipment, smart phones, mobile computers, digital broadcast terminals, personal digital assistants, portable multimedia players (PMP) and navigators.

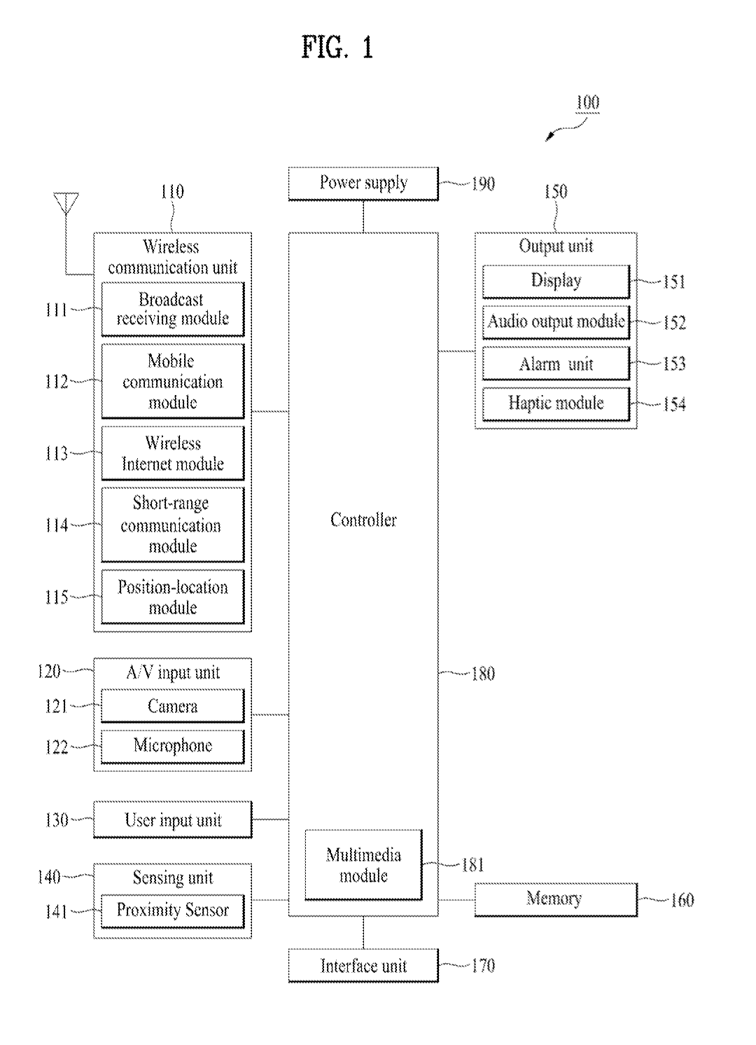

FIG. 1 is a block diagram of a mobile terminal 100 in accordance with an embodiment of the present invention. FIG. 1 shows the mobile terminal 100 according to one embodiment of the present invention includes a wireless communication unit 110, an AN (audio/video) input unit 120, a user input unit 130, a sensing unit 140, an output unit 150, a memory 160, an interface unit 170, a controller 180, a power supply unit 190 and the like. FIG. 1 shows the mobile terminal 100 having various components, but it is understood that implementing all of the illustrated components is not a requirement. Greater or fewer components may alternatively be implemented.

In the following description, the above elements of the mobile terminal 100 are explained in sequence.

First of all, the wireless communication unit 110 typically includes one or more components which permits wireless communication between the mobile terminal 100 and a wireless communication system or network within which the mobile terminal 100 is located. For instance, the wireless communication unit 110 can include a broadcast receiving module 111, a mobile communication module 112, a wireless internet module 113, a short-range communication module 114, a position-location module 115 and the like.

The broadcast receiving module 111 receives a broadcast signal and/or broadcast associated information from an external broadcast managing server via a broadcast channel.

The broadcast channel may include a satellite channel and a terrestrial channel.

The broadcast managing server generally refers to a server which generates and transmits a broadcast signal and/or broadcast associated information or a server which is provided with a previously generated broadcast signal and/or broadcast associated information and then transmits the provided signal or information to a terminal The broadcast signal may be implemented as a TV broadcast signal, a radio broadcast signal, and a data broadcast signal, among others. If desired, the broadcast signal may further include a broadcast signal combined with a TV or radio broadcast signal.

At least two broadcast receiving modules 111 can be provided to the mobile terminal 100 in pursuit of simultaneous receptions of at least two broadcast channels or broadcast channel switching facilitation.

The broadcast associated information includes information associated with a broadcast channel, a broadcast program, a broadcast service provider, etc. And, the broadcast associated information can be provided via a mobile communication network. In this case, the broadcast associated information can be received by the mobile communication module 112.

The broadcast associated information can be implemented in various forms. For instance, broadcast associated information may include an electronic program guide (EPG) of digital multimedia broadcasting (DMB) and electronic service guide (ESG) of digital video broadcast-handheld (DVB-H).

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), DVB-CBMS, OMA-BCAST, the data broadcasting system known as media forward link only (MediaFLO®) and integrated services digital broadcast-terrestrial (ISDB-T). Optionally, the broadcast receiving module 111 can be configured suitable for other broadcasting systems as well as the above-explained digital broadcasting systems.

The broadcast signal and/or broadcast associated information received by the broadcast receiving module 111 may be stored in a suitable device, such as a memory 160.

The mobile communication module 112 transmits/receives wireless signals to/from one or more network entities (e.g., base station, external terminal, server, etc.) via a mobile network such as GSM(Gobal System for Mobile communications), CDMA(Code Division Multiple Access), WCDMA(Wideband CDMA) and so on. Such wireless signals may represent audio, video, and data according to text/multimedia message transceivings, among others.

The wireless internet module 113 supports Internet access for the mobile terminal 100. This module may be internally or externally coupled to the mobile terminal 100. In this case, the wireless Internet technology can include WLAN(Wireless LAN) (Wi-Fi), Wibro (Wireless broadband), Wimax (World Interoperability for Microwave Access), HSDPA(High Speed Downlink Packet Access), GSM, CDMA, WCDMA, LTE (Long Term Evolution) etc.

Wireless internet access by Wibro, HSPDA, GSM, CDMA, WCDMA, LTE or the like is achieved via a mobile communication network. In this aspect, the wireless internet module 113 configured to perform the wireless internet access via the mobile communication network can be understood as a sort of the mobile communication module 112.

The short-range communication module 114 facilitates relatively short-range communications. Suitable technologies for implementing this module include radio frequency identification (RFID), infrared data association (IrDA), ultra-wideband (UWB), as well at the networking technologies commonly referred to as Bluetooth and ZigBee, to name a few.

The position-location module 115 identifies or otherwise obtains the location of the mobile terminal 100. If desired, this module may be implemented with a global positioning system (GPS) module.

According to the current technology, the GPS module 115 is able to precisely calculate current 3-dimensional position information based on at least one of longitude, latitude and altitude and direction (or orientation) by calculating distance information and precise time information from at least three satellites and then applying triangulation to the calculated information. Currently, location and time informations are calculated using three satellites, and errors of the calculated location position and time informations are then amended using another satellite. Besides, the GPS module 115 is able to calculate speed information by continuously calculating a real-time current location.

Referring to FIG. 1, the audio/video (AN) input unit 120 is configured to provide audio or video signal input to the mobile terminal 100. As shown, the AN input unit 120 includes a camera 121 and a microphone 122. The camera 121 receives and processes image frames of still pictures or video, which are obtained by an image sensor in a video call mode or a photographing mode. And, the processed image frames can be displayed on the display 151.

The image frames processed by the camera 121 can be stored in the memory 160 or can be externally transmitted via the wireless communication unit 110. Optionally, at least two cameras 121 can be provided to the mobile terminal 100 according to environment of usage.

The microphone 122 receives an external audio signal while the portable device is in a particular mode, such as phone call mode, recording mode and voice recognition. This audio signal is processed and converted into electric audio data. The processed audio data is transformed into a format transmittable to a mobile communication base station via the mobile communication module 112 in case of a call mode. The microphone 122 typically includes assorted noise removing algorithms to remove noise generated in the course of receiving the external audio signal.

The user input unit 130 generates input data responsive to user manipulation of an associated input device or devices. Examples of such devices include a keypad, a dome switch, a touchpad (e.g., static pressure/capacitance), a jog wheel, a jog switch, etc.

The sensing unit 140 provides sensing signals for controlling operations of the mobile terminal 100 using status measurements of various aspects of the mobile terminal For instance, the sensing unit 140 may detect an open/close status of the mobile terminal 100, relative positioning of components (e.g., a display and keypad) of the mobile terminal 100, a change of position of the mobile terminal 100 or a component of the mobile terminal 100, a presence or absence of user contact with the mobile terminal 100, orientation or acceleration/deceleration of the mobile terminal 100, and free-falling of the mobile terminal 100. As an example, consider the mobile terminal 100 being configured as a slide-type mobile terminal In this configuration, the sensing unit 140 may sense whether a sliding portion of the mobile terminal is open or closed. Other examples include the sensing unit 140 sensing the presence or absence of power provided by the power supply 190, the presence or absence of a coupling or other connection between the interface unit 170 and an external device. And, the sensing unit 140 can include a proximity sensor 141.

The output unit 150 generates outputs relevant to the senses of sight, hearing, touch and the like. And, the output unit 150 includes the display 151, an audio output module 152, an alarm unit 153, a haptic module 154, a projector module 155 and the like.

The display 151 is typically implemented to visually display (output) information associated with the mobile terminal 100. For instance, if the mobile terminal is operating in a phone call mode, the display will generally provide a user interface (UI) or graphical user interface (GUI) which includes information associated with placing, conducting, and terminating a phone call. As another example, if the mobile terminal 100 is in a video call mode or a photographing mode, the display 151 may additionally or alternatively display images which are associated with these modes, the UI or the GUI.

The display module 151 may be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal 100 may include one or more of such displays.

Some of the above displays can be implemented in a transparent or optical transmittive type, which can be named a transparent display. As a representative example for the transparent display, there is TOLED (transparent OLED) or the like. A rear configuration of the display 151 can be implemented in the optical transmittive type as well. In this configuration, a user is able to see an object in rear of a terminal body via the area occupied by the display 151 of the terminal body.

At least two displays 151 can be provided to the mobile terminal 100 in accordance with the implemented configuration of the mobile terminal 100. For instance, a plurality of displays can be arranged on a single face of the mobile terminal 100 in a manner of being spaced apart from each other or being built in one body. Alternatively, a plurality of displays can be arranged on different faces of the mobile terminal 100.

In case that the display 151 and a sensor for detecting a touch action (hereinafter called ‘touch sensor’) configures a mutual layer structure (hereinafter called ‘touchscreen’), it is able to use the display 151 as an input device as well as an output device. In this case, the touch sensor can be configured as a touch film, a touch sheet, a touchpad or the like.

The touch sensor can be configured to convert a pressure applied to a specific portion of the display 151 or a variation of a capacitance generated from a specific portion of the display 151 to an electric input signal. Moreover, it is able to configure the touch sensor to detect a pressure of a touch as well as a touched position or size.

If a touch input is made to the touch sensor, signal(s) corresponding to the touch is transferred to a touch controller. The touch controller processes the signal(s) and then transfers the processed signal(s) to the controller 180. Therefore, the controller 180 is able to know whether a prescribed portion of the display 151 is touched.

Referring to FIG. 1, a proximity sensor (141) can be provided to an internal area of the mobile terminal 100 enclosed by the touchscreen or around the touchscreen. The proximity sensor is the sensor that detects a presence or non-presence of an object approaching a prescribed detecting surface or an object existing around the proximity sensor using an electromagnetic field strength or infrared ray without mechanical contact. Hence, the proximity sensor has durability longer than that of a contact type sensor and also has utility wider than that of the contact type sensor.

The proximity sensor can include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. In case that the touchscreen includes the electrostatic capacity proximity sensor, it is configured to detect the proximity of a pointer using a variation of electric field according to the proximity of the pointer. In this case, the touchscreen (touch sensor) can be classified as the proximity sensor.

The proximity sensor detects a proximity touch and a proximity touch pattern (e.g., a proximity touch distance, a proximity touch duration, a proximity touch position, a proximity touch shift state, etc.). And, information corresponding to the detected proximity touch action and the detected proximity touch pattern can be outputted to the touchscreen.

The audio output module 152 functions in various modes including a call-receiving mode, a call-placing mode, a recording mode, a voice recognition mode, a broadcast reception mode and the like to output audio data which is received from the wireless communication unit 110 or is stored in the memory 160. During operation, the audio output module 152 outputs audio relating to a particular function (e.g., call received, message received, etc.). The audio output module 152 is often implemented using one or more speakers, buzzers, other audio producing devices, and combinations thereof

The alarm unit 153 is output a signal for announcing the occurrence of a particular event associated with the mobile terminal 100. Typical events include a call received event, a message received event and a touch input received event. The alarm unit 153 is able to output a signal for announcing the event occurrence by way of vibration as well as video or audio signal. The video or audio signal can be outputted via the display 151 or the audio output unit 152. Hence, the display 151 or the audio output module 152 can be regarded as a part of the alarm unit 153.

The haptic module 154 generates various tactile effects that can be sensed by a user. Vibration is a representative one of the tactile effects generated by the haptic module 154. Strength and pattern of the vibration generated by the haptic module 154 are controllable. For instance, different vibrations can be outputted in a manner of being synthesized together or can be outputted in sequence.

The haptic module 154 is able to generate various tactile effects as well as the vibration. For instance, the haptic module 154 generates the effect attributed to the arrangement of pins vertically moving against a contact skin surface, the effect attributed to the injection/suction power of air though an injection/suction hole, the effect attributed to the skim over a skin surface, the effect attributed to the contact with electrode, the effect attributed to the electrostatic force, the effect attributed to the representation of hold/cold sense using an endothermic or exothermic device and the like.

The haptic module 154 can be implemented to enable a user to sense the tactile effect through a muscle sense of finger, arm or the like as well as to transfer the tactile effect through a direct contact. Optionally, at least two haptic modules 154 can be provided to the mobile terminal 100 in accordance with the corresponding configuration type of the mobile terminal 100.

The projector module 155 is the element for performing an image projector function using the mobile terminal 100. And, the projector module 155 is able to display an image, which is identical to or partially different at least from the image displayed on the display unit 151, on an external screen or wall according to a control signal of the controller 180.

In particular, the projector module 155 can include a light source (not shown in the drawing) generating light (e.g., laser) for projecting an image externally, an image producing means (not shown in the drawing) for producing an image to output externally using the light generated from the light source, and a lens (not shown in the drawing) for enlarging to output the image externally in a predetermined focus distance. And, the projector module 155 can further include a device (not shown in the drawing) for adjusting an image projected direction by mechanically moving the lens or the whole module.

The projector module 155 can be classified into a CRT (cathode ray tube) module, an LCD (liquid crystal display) module, a DLP (digital light processing) module or the like according to a device type of a display means. In particular, the DLP module is operated by the mechanism of enabling the light generated from the light source to reflect on a DMD (digital micro-mirror device) chip and can be advantageous for the downsizing of the projector module 151.

Preferably, the projector module 155 can be provided in a length direction of a lateral, front or backside direction of the mobile terminal 100. And, it is understood that the projector module 155 can be provided to any portion of the mobile terminal 100 according to the necessity thereof.

The memory unit 160 is generally used to store various types of data to support the processing, control, and storage requirements of the mobile terminal 100. Examples of such data include program instructions for applications operating on the mobile terminal 100, contact data, phonebook data, messages, audio, still pictures (or photo), moving pictures, etc. And, a recent use history or a cumulative use frequency of each data (e.g., use frequency for each phonebook, each message or each multimedia) can be stored in the memory unit 160. Moreover, data for various patterns of vibration and/or sound outputted in case of a touch input to the touchscreen can be stored in the memory unit 160.

The memory 160 may be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory, etc.), or other similar memory or data storage device. And, the mobile terminal 100 is able to operate in association with a web storage for performing a storage function of the memory 160 on Internet.

The interface unit 170 is often implemented to couple the mobile terminal 100 with external devices. The interface unit 170 receives data from the external devices or is supplied with the power and then transfers the data or power to the respective elements of the mobile terminal 100 or enables data within the mobile terminal 100 to be transferred to the external devices. The interface unit 170 may be configured using a wired/wireless headset port, an external charger port, a wired/wireless data port, a memory card port, a port for coupling to a device having an identity module, audio input/output ports, video input/output ports, an earphone port and/or the like.

The identity module is the chip for storing various kinds of information for authenticating a use authority of the mobile terminal 100 and can include User Identify Module (UIM), Subscriber Identify Module (SIM), Universal Subscriber Identity Module (USIM) and/or the like. A device having the identity module (hereinafter called ‘identity device’) can be manufactured as a smart card. Therefore, the identity device is connectible to the mobile terminal 100 via the corresponding port.

When the mobile terminal 110 is connected to an external cradle, the interface unit 170 becomes a passage for supplying the mobile terminal 100 with a power from the cradle or a passage for delivering various command signals inputted from the cradle by a user to the mobile terminal 100. Each of the various command signals inputted from the cradle or the power can operate as a signal enabling the mobile terminal 100 to recognize that it is correctly loaded in the cradle.

The controller 180 typically controls the overall operations of the mobile terminal 100. For example, the controller 180 performs the control and processing associated with voice calls, data communications, video calls, etc. The controller 180 may include a multimedia module 181 that provides multimedia playback. The multimedia module 181 may be configured as part of the controller 180, or implemented as a separate component.

Moreover, the controller 180 is able to perform a pattern (or image) recognizing process for recognizing a writing input and a picture drawing input carried out on the touchscreen as characters or images, respectively.

The power supply unit 190 provides power required by the various components for the mobile terminal 100. The power may be internal power, external power, or combinations thereof.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

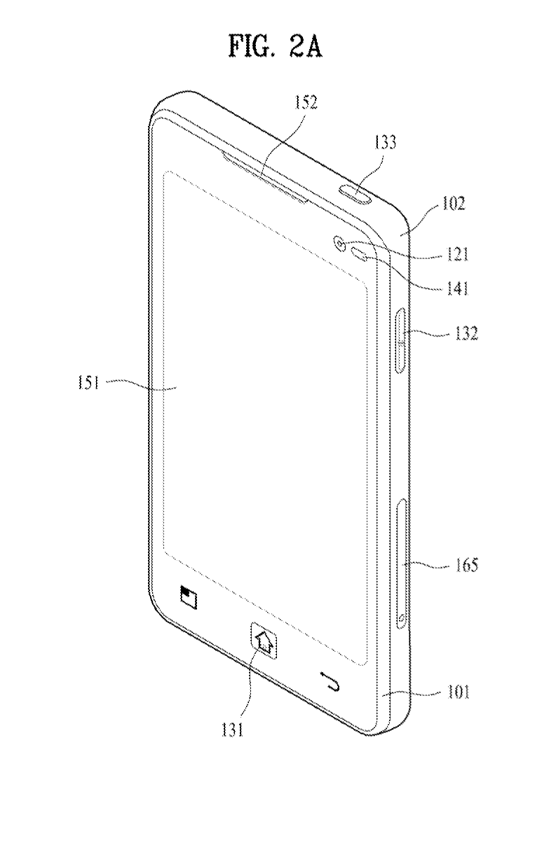

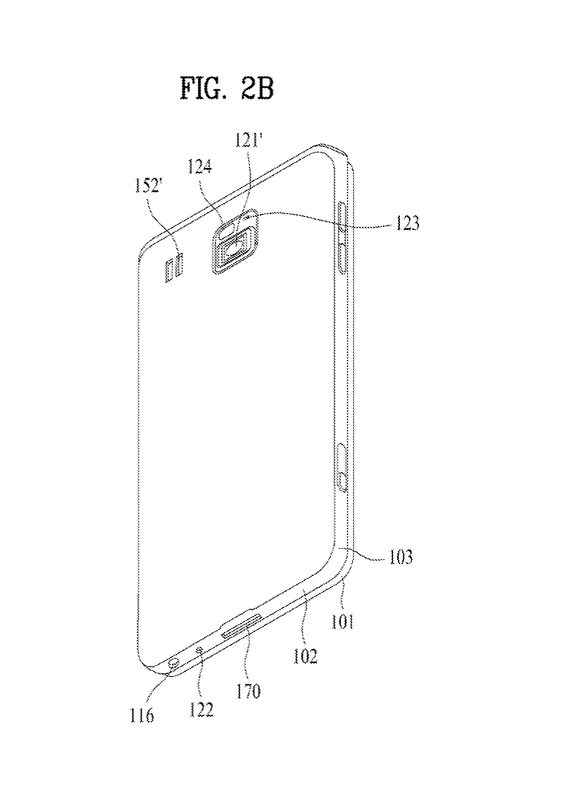

FIG. 2A is a front perspective diagram of a mobile terminal according to one embodiment of the present invention.

The mobile terminal 100 shown in the drawing has a bar type terminal body. Yet, the mobile terminal 100 may be implemented in a variety of different configurations. Examples of such configurations include folder-type, slide-type, rotational-type, swing-type and combinations thereof For clarity, further disclosure will primarily relate to a bar-type mobile terminal 100. However such teachings apply equally to other types of mobile terminals.

Referring to FIG. 2A, the mobile terminal 100 includes a case (casing, housing, cover, etc.) configuring an exterior thereof In the present embodiment, the case can be divided into a front case 101 and a rear case 102. Various electric/electronic parts are loaded in a space provided between the front and rear cases 101 and 102. Optionally, at least one middle case can be further provided between the front and rear cases 101 and 102 in addition.

The cases 101 and 102 are formed by injection molding of synthetic resin or can be formed of metal substance such as stainless steel (STS), titanium (Ti) or the like for example.

A display 151, an audio output unit 152, a camera 121, user input units 130/131 and 132, a microphone 122, an interface 180 and the like can be provided to the terminal body, and more particularly, to the front case 101.

The display 151 occupies most of a main face of the front case 101. The audio output unit 151 and the camera 121 are provided to an area adjacent to one of both end portions of the display 151, while the user input unit 131 and the microphone 122 are provided to another area adjacent to the other end portion of the display 151. The user input unit 132 and the interface 170 can be provided to lateral sides of the front and rear cases 101 and 102.

The input unit 130 is manipulated to receive a command for controlling an operation of the terminal 100. And, the input unit 130 is able to include a plurality of manipulating units 131 and 132. The manipulating units 131 and 132 can be named a manipulating portion and may adopt any mechanism of a tactile manner that enables a user to perform a manipulation action by experiencing a tactile feeling.

Content inputted by the first or second manipulating unit 131 or 132 can be diversely set. For instance, such a command as start, end, scroll and the like is inputted to the first manipulating unit 131. And, a command for a volume adjustment of sound outputted from the audio output unit 152, a command for a switching to a touch recognizing mode of the display 151 or the like can be inputted to the second manipulating unit 132.

FIG. 2B is a perspective diagram of a backside of the terminal shown in FIG. 2A.

Referring to FIG. 2B, a camera 121′ can be additionally provided to a backside of the terminal body, and more particularly, to the rear case 102. The camera 121 has a photographing direction that is substantially opposite to that of the former camera 121 shown in FIG. 21A and may have pixels differing from those of the firmer camera 121.

Preferably, for instance, the former camera 121 has low pixels enough to capture and transmit a picture of user's face for a video call, while the latter camera 121′ has high pixels for capturing a general subject for photography without transmitting the captured subject. And, each of the cameras 121 and 121′ can be installed at the terminal body to be rotated or popped up.

A flash 123 and a mirror 124 are additionally provided adjacent to the camera 121′. The flash 123 projects light toward a subject in case of photographing the subject using the camera 121′. In case that a user attempts to take a picture of the user (self-photography) using the camera 121′, the mirror 124 enables the user to view user's face reflected by the mirror 124.

An additional audio output unit 152′ can be provided to the backside of the terminal body. The additional audio output unit 152′ is able to implement a stereo function together with the former audio output unit 152 shown in FIG. 2A and may be used for implementation of a speakerphone mode in talking over the terminal

A broadcast signal receiving antenna 124 can be additionally provided to the lateral side of the terminal body as well as an antenna for communication or the like. The antenna 124 constructing a portion of the broadcast receiving module 111 shown in FIG. 1 can be retractably provided to the terminal body.

A power supply unit 190 for supplying a power to the terminal 100 is provided to the terminal body. And, the power supply unit 190 can be configured to be built within the terminal body. Alternatively, the power supply unit 190 can be configured to be detachably connected to the terminal body.

A touchpad for detecting a touch can be additionally provided to the rear case 102. The touchpad can be configured in a light transmittive type like the display 151. In this case, if the display 151 is configured to output visual information from its both faces, it is able to recognize the visual information via the touchpad as well. The information outputted from both of the faces can be entirely controlled by the touchpad. Alternatively, a display is further provided to the touchpad so that a touchscreen can be provided to the rear case 102 as well.

The touchpad is activated by interconnecting with the display 151 of the front case 101. The touchpad can be provided in rear of the display 151 in parallel. The touchpad can have a size equal to or smaller than that of the display 151.

The configuration modules of the mobile terminal 100 will be described in relation with embodiments of the disclosure will be as follows.

The controller 180 implements a camera application in accordance with a user command for activating the camera 121 and the camera 121 acquires an image. The image acquired by the camera 121 may be a preview image or a file-image stored after acquired by a photographing command.

The display 151 may display the image acquired by the camera 121.

The wireless communication unit 110 requests information about a person contained in the image from an external device and receives the information on the person from the external device. The person information is referred to as “first information”

The display 151 displays the received first information on the displayed image. The first information is overlaid on the image of the display 151.

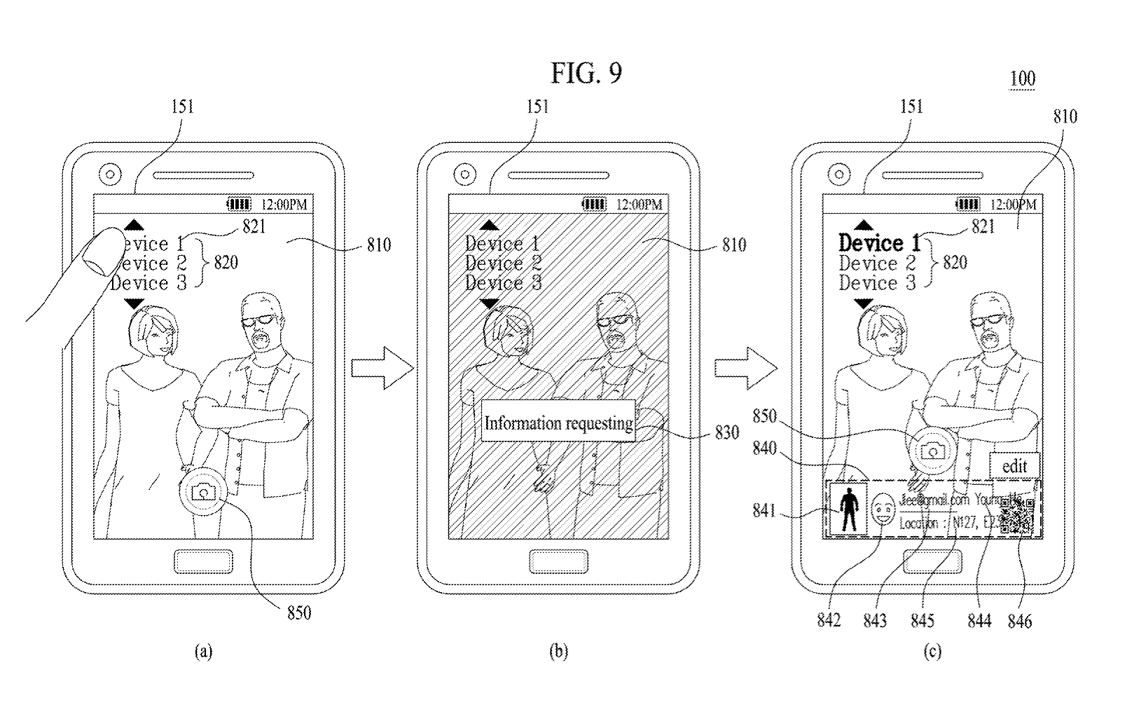

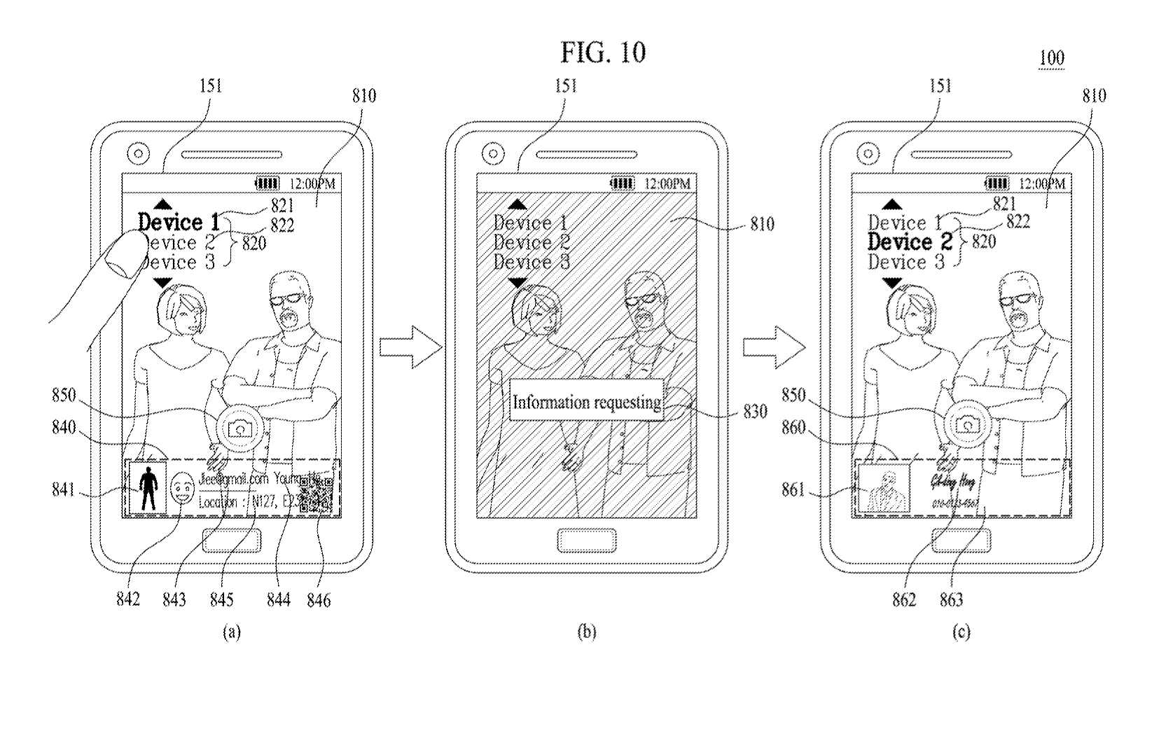

According to the present embodiment, the controller 180 searches for information-sharable external devices and displays the result of the searching on the display 151. The wireless communication unit 110 may request first information from the external device selected by the user on a list of the external devices collected based on the displayed result of the searching, which will be described as follows, referring to FIGS. 9 and 10.

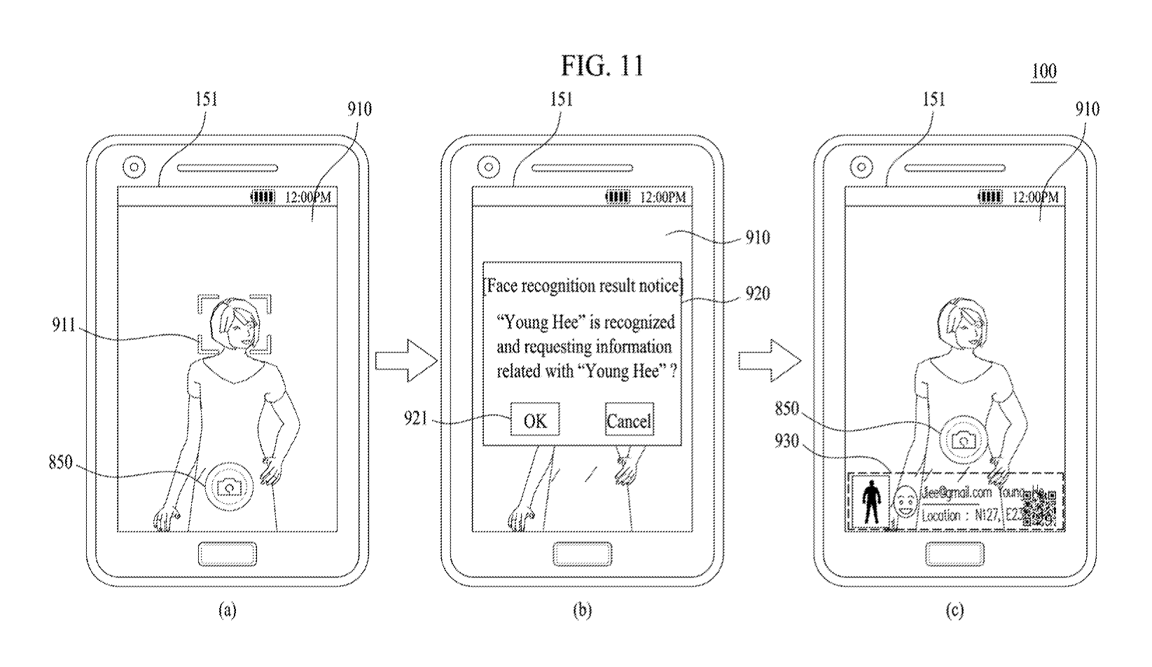

In one embodiment, the controller 180 implements face recognition for the person contained in the displayed image and specifies the external device from which it requests the first information, using the recognized person information. Hereinafter, the recognized person information is referred to as “second information” and the wireless communication unit 110 may request the first information from the specified external device, which will be described as follows, referring to FIGS. 11, 12 and 13.

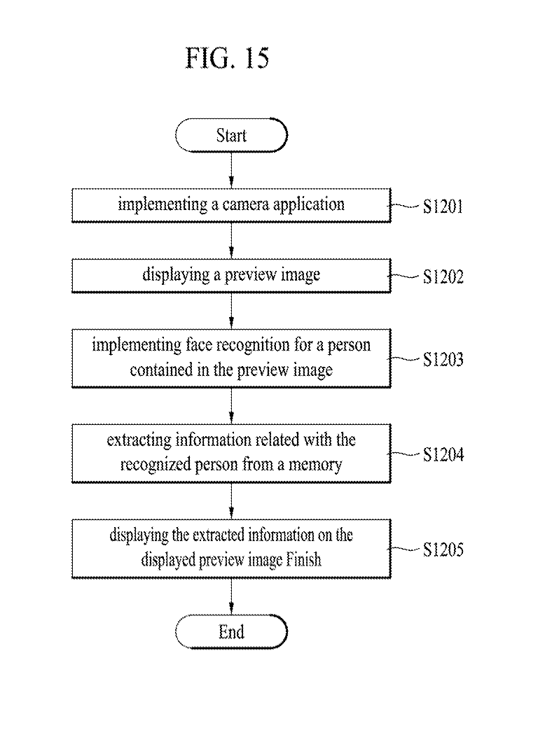

In one embodiment, the controller 180 implements face recognition for the person contained in the displayed image, unless receiving the first information from the external device. The controller 180 may extract necessary from the memory 160 based on the result of the face recognition, which will be described as follows, referring to FIGS. 15, 16, 17, 18, 19 and 20.

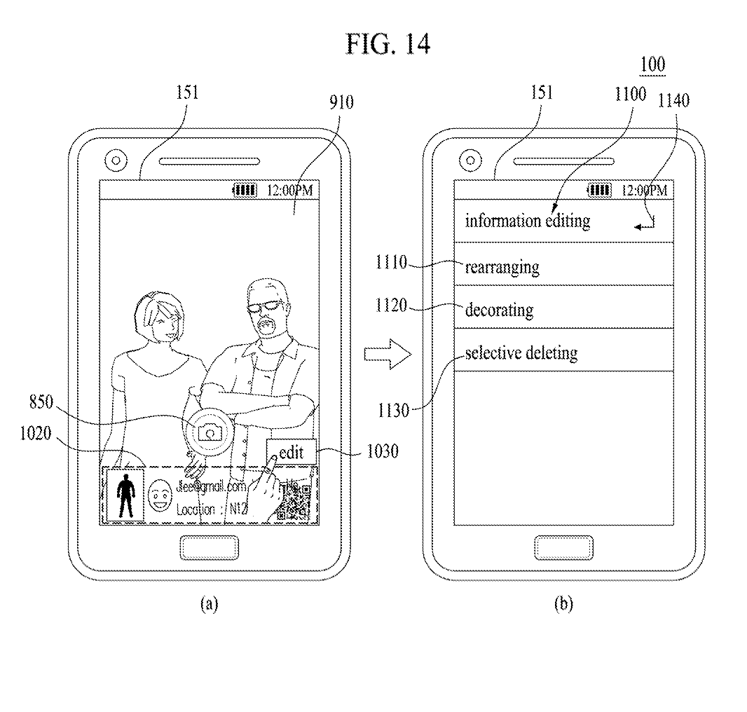

The first information overlaid on the displayed image may be edited by the user, which will be described as follows, referring to FIG. 14.

Hereinafter, embodiments of the disclosure will be described in detail, referring to the accompanying drawings.

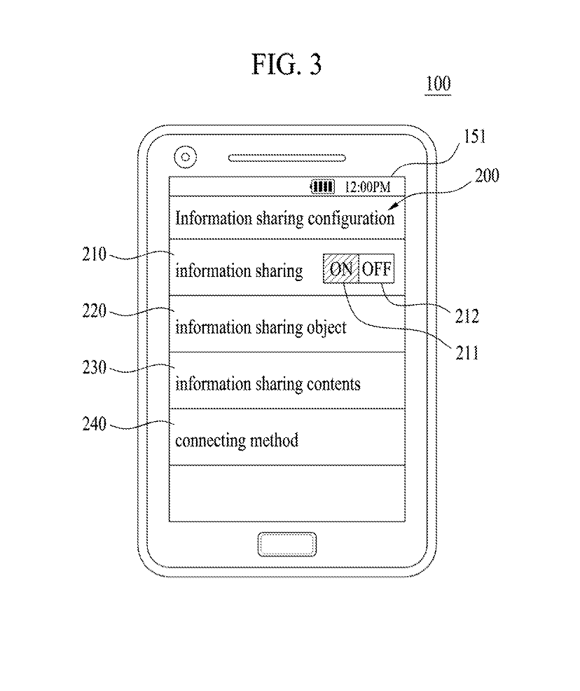

In one embodiment, there may basically be a mobile terminal as a subject of picture capturing and an external device possessed by a person as an object of picture capturing. The mobile terminal as the subject of the picture capturing is referred to as “a first mobile terminal” and the external device possessed by the person which is the object of the picture capturing as “a second mobile terminal”, such that the first mobile terminal may request information sharing from the second mobile terminal and compose the information received from the second mobile terminal with the image. Referring to FIGS. 3, 4, 5, 6 and 7, an example of a method for configuration for information sharing will be described, using the second mobile terminal.

In the embodiments of the disclosure, “an information-sharing function” means that person information is transmitted between the first and second mobile terminals to compose the person information received from the second mobile terminal with the image acquired by the camera embedded in the first mobile terminal In a position of the first mobile terminal, the information sharing function means a series of processes for requesting information from the second mobile terminal and receiving the information from the second terminal In a position of the second mobile terminal, it means a series of processes for sending preset information to the first mobile terminal in response to a request made by the first mobile terminal.

FIGS. 3 through 7 are diagrams illustrating examples of the configuration screen displayed on the display of the mobile terminal according to the embodiment of the disclosure.

When the user selects “information sharing set menu” in a state of implementing the configuration application, a screen 200 for configurating the information sharing shown in FIG. 3 may be displayed on the display 151.

For instance, the information sharing configuration screen 200 may include a first menu 210 for setting on/off of the information sharing function, a second menu 220 for configurating an information-sharing object, a third menu 230 for configurating contents of information sharing and a fourth menu 240 for configurating a connection method of information sharing.

When the user selects an ON button 211 in the first menu 210, the ON button 211 is displayed in an activated state and the information sharing function is activated. Otherwise, when the user selects an OFF button 212 in the first menu 210, the OFF button 212 is displayed in an activated state and the information sharing function is deactivated. In case the information sharing function is deactivated, the second menu 220 through the fourth menu 240 may be displayed in a deactivated state.

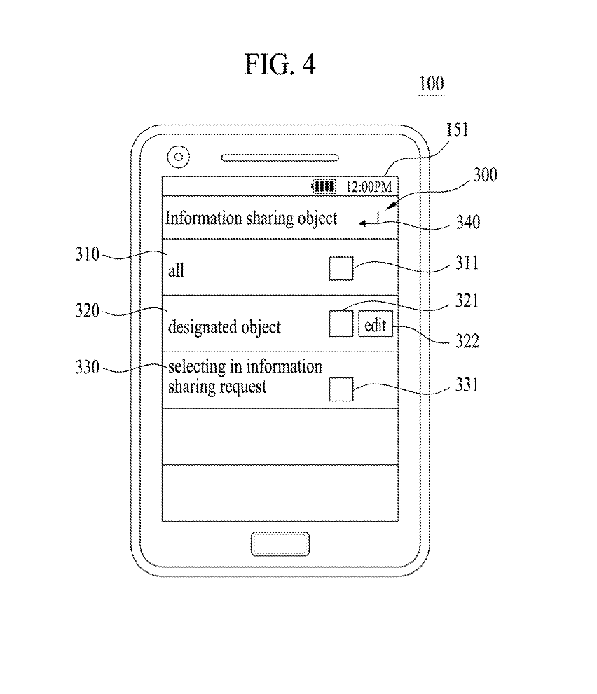

When the user selects the second menu 220 for configurating the object of the information sharing, a configuration screen 300 for configurating the information sharing object shown in FIG. 4 may be displayed on the display 151.

The configuration screen 300 for configurating the information sharing object is configured to receive a user command for configurating with which mobile terminal is shared the information preset by the user of the mobile terminal 100 (or the second mobile terminal).

For instance, the configuration screen 300 for configurating the information sharing object may include a first menu 310 for selecting to share the preset information stored in the second mobile terminal with all of the mobile terminals requesting the information, a second menu 320 for selecting to share the preset information with only some designated mobile terminals, and a third menu 330 for selecting whether to share the information whenever the information request is made from an unselective mobile terminal.

When the user touches a check box 311 in the first menu 310, the controller 180 of the mobile terminal 100 (or the second mobile terminal) controls the wireless communication unit 110 to transmit preset information to all of the mobile terminals (or the first mobile terminals) requesting the information sharing.

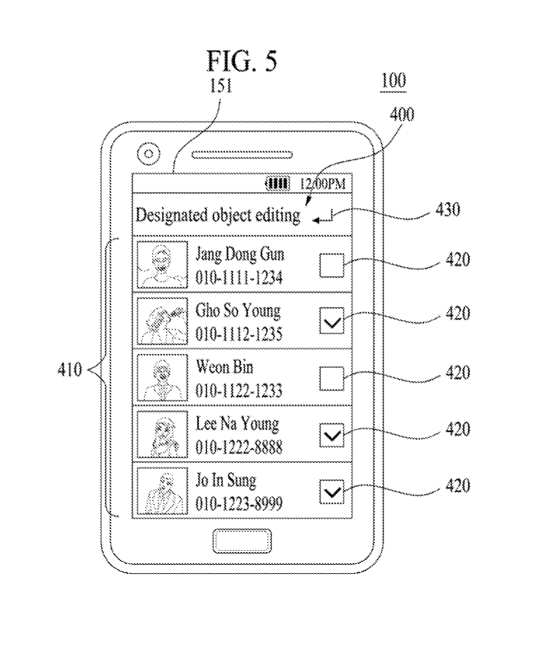

The user touches a check box 321 in the second menu 320 and the controller 180 of the mobile terminal 100 (or the second mobile terminal) controls the wireless communication unit 110 to transmit the preset information to a mobile terminal having permission to share the information, only when a mobile terminal permitted to share the information makes a request for the information sharing. The user selects an edit button 322 in the second menu 320 and edits a list of the mobile terminals permitted to share the information. The editing for the list of the mobile terminals permitted to share the information will be described later, referring to FIG. 5.

When the user touches a check box 331 in the third menu 330, the controller 180 of the mobile terminal 100 (or the second mobile terminal) may control the display 151 to display a graphic user interface (GUI) so as to receive a user command configurating whether to permit the information sharing only when an unselective mobile terminal (or the first mobile terminal) requests the information sharing. Also, the controller 180 may control the wireless communication unit 110 to transmit the preset information to the mobile terminal (or the first mobile terminal) only when the user permits the information sharing.

When the configuration of the information sharing object is complete, the user touches an EXIT button 340 to return to the configuration screen 200 shown in FIG. 3.

In contrast, when the user selects an edit button 222 in the second menu 320, a configuration screen 400 for editing a designated object may be displayed on the display 151 as shown in FIG. 5.

The configuration screen 400 for editing the designating object is configured to receive a user command allowing the user to edit the list of the mobile terminals (or the first mobile terminals) permitted to share the preset information.

For instance, on the configuration screen 400 for editing the designated object may be displayed a whole list 410 of information-sharable mobile terminals. The whole list 410 may be formed based on a list of friends registered in a contact application or a messenger application.

The user may touch a check box 420 corresponding to a mobile terminal which will be permitted to share the information and select the mobile terminal.

Once the designated object editing is complete, the user touches the EXIT button 430 to return the configuration screen 300 shown in FIG. 4.

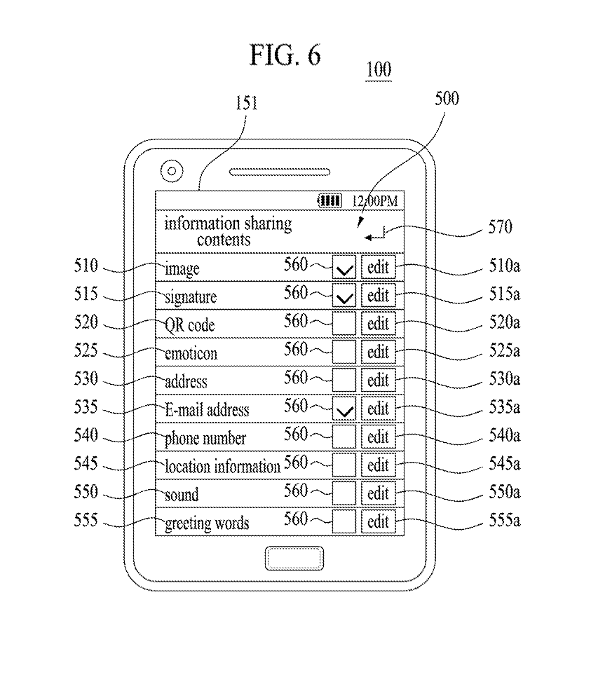

Meanwhile, when the user selects a third menu 230 for configurating the contents of the sharing information in the configuration screen 200 shown in FIG. 3, a configuration screen 500 for configurating contents of the sharing information shown in FIG. 6 may be displayed on the display 151.

The configuration screen 500 for configurating the contents of the sharing information may be to receive a user command to specify contents of the information which will be sharing with an external mobile terminal (the first mobile terminal).

For instance, The configuration screen 500 for configurating the contents of the sharing information may include a first menu 510 for selecting whether images are contained in the sharing information and to editing the images; a second menu 515 for selecting whether to contain a signature in the sharing information and editing the signature; a third menu 520 for selecting to contain QR code in the sharing information and editing the QR code; a fourth menu 525 for selecting whether to contain emoticon in the sharing information and editing the emoticon; a fifth menu 530 for selecting whether to contain an address in the sharing information and editing the address; a sixth menu 535 for selecting whether to contain an E-mail address in the sharing information and editing the E-mail address; a seventh menu 540 for selecting whether to contain location information in the sharing information and editing the location information; a ninth menu 550 for selecting whether to contain sound in the sharing information and editing the sound; and a tenth menu 555 for selecting to whether to contain greeting words in the sharing information and editing the greeting words. However, the menus shown in FIG. 6 are only various embodiments and the configuration screen 500 for configurating the contents of the sharing information may include more or less menus than those described above.

The user may touch a check box 560 corresponding to the information which will be shared with the external mobile terminal (or the first mobile terminal) and configurate contents of the sharing information.

When the user selects an edit button 510a in the first menu 510, an image edit image (not shown) may be displayed on the display 151. The user may select the image which will be contained in the sharing information and edit the selected image through the image edit screen. For instance, the image which will be contained in the sharing information may be selected from the images stored in a gallery application. The editing of the selected image may use a series of picture edit functions provided by the gallery application.

When the user selects an edit button 515a in the second menu, a signature edit screen (not shown) may be displayed on the display 151. The user may create a signature which will be contained in the sharing information or select an image which will be used as a signature out of the images stored in the gallery application or edit the made (or selected) signature, through the QR code edit screen.

When the user selects an edit button 520a in the third menu 520, a QR code edit screen (not shown) may be displayed on the display 151. The user may directly create a QR code contained in the sharing information or select an image which will be used as a QR code out of the images stored in the gallery application or edit the made (or edited) QR code, through the QR code editing screen.

When the user selects an edit button 525a in the fourth menu 525, an emoticon edit screen (not shown) may be displayed on the display 151. The user may directly make an emoticon contained in the sharing information or select an image which will be used as an emoticon out of the images stored in the gallery application or edit the made (or selected) emoticon, through the emoticon edit screen.

When the user selects an edit button 530a in the fifth menu 530, an address edit screen (not shown) may be displayed on the display 151. The user may directly enter an address contained in the sharing information or select an image which will be used as an address out of the image stored in the gallery application or edit the written (or selected) address, through the address edit screen.

When the user selects an edit button 535a in the sixth button 535, an E-mail address edit screen (not shown) may be displayed on the display 151. The user may directly enter an E-mail address contained in the sharing information or select an image which will be used as an E-mail address out of the image stored in the gallery or edit the entered (or selected) E-mail address, through the E-mail address edit screen.

When the user selects an edit button 540a in the seventh menu 540, a phone number edit screen (not shown) may be displayed on the display 151. The user may directly enter a phone number contained in the sharing information or select an image which will be used as a phone number out of the image stored in the gallery or edit the entered (or selected) phone number, through the phone number edit screen.

When the user selects an edit button 545a in the eighth menu 545, a location information edit screen (not shown) may be displayed on the display 151. The user may select a display type (e.g., East or E to express the east) of location information which will be contained in the sharing information (e.g., coordinate information) or edit the display type of the location information, through the location information edit screen.

When the user selects an edit button 550a in the ninth menu 550, a sound edit screen (not shown) may be displayed on the display 151. The user may record sound which will be contained in the sharing information or edit the recorded sound, through the sound edit screen.

When the user selects an edit button 555a in the tenth menu 555, a greeting words edit screen (not shown) may be displayed on the display 151. The user may directly enter greeting words which will be contained in the sharing information or select an image which will be used as greeting words out of the images stored in the gallery application or edit the entered (or selected) greeting words.

Once the configuration of the contents contained in the sharing information is complete, the user touches an EXIT button 570 to return to the configuration screen 200 shown in FIG. 3.

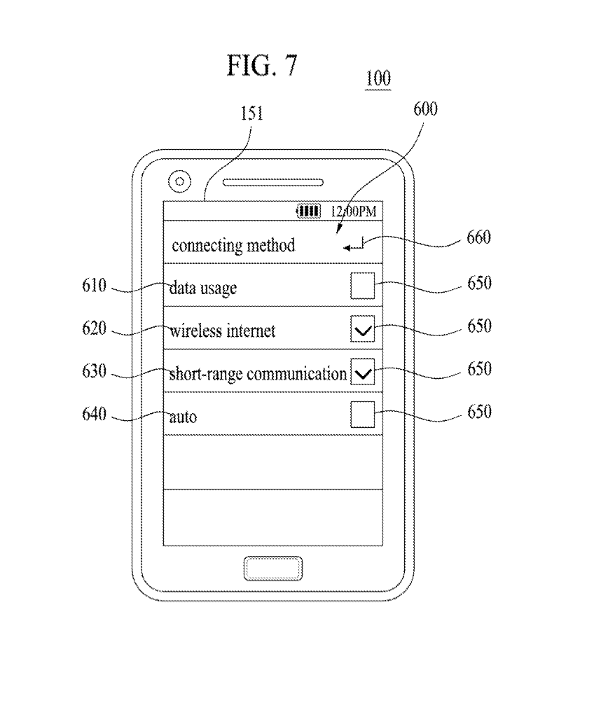

Meanwhile, when the user selects a fourth menu 240 for configurating a connection method for the information sharing in the configuration screen 200 shown in FIG. 3, a configuration screen 600 for configurating a connecting method shown in FIG. 7 may be displayed on the display 151.

The configuration screen 600 for configurating the connecting method may be to receive a user command for configurating a communication connection state with the first mobile terminal In other words, when the second mobile terminal communicates with the first mobile terminal via a communication connection method selected from the configuration screen 600, the information sharing with the first mobile terminal may be performed.

For instance, the configuration screen 600 for configurating the connecting method may include a first menu 610 for permitting the information sharing when the mobile communication module 112 enables the second mobile terminal to communicate with the first mobile terminal wirelessly; a second menu 620 for permitting the information sharing when the wireless internet module 113 enables the second mobile terminal to communicate with the first mobile terminal wirelessly; a third menu 630 for permitting the information sharing when the short range communication module 114 enables the wireless communication with the first mobile terminal; and a fourth menu 640 for configurating the connecting method in accordance with a preset condition automatically.

The user touches a check box 650 corresponding to a desired communication connecting method in the information sharing and configurate the communication connecting method with the first mobile terminal in the information sharing. A plurality of communication connecting methods may be selected in the information sharing.

When the user selects the first menu 610, the controller 180 controls to transmit the information preset in accordance with the information request made by the first mobile terminal in case the wireless communication with the first mobile terminal is enabled by the mobile terminal module 112.

When the user selects the second menu 620, the controller 180 controls to transmit the information preset in accordance with the information request made by the first mobile terminal in case the wireless communication with the first mobile terminal is enabled by the wireless internet module 113.

When the user selects the third menu 630, the controller 180 controls to transmit the information preset in accordance with the information request made by the first mobile terminal in case the wireless communication with the first mobile terminal is enabled by the short range communication module 113.

When the user selects the fourth menu 640, the information may be shared with the first mobile terminal via a high priority one out of various wireless communication connecting methods. For instance, the priority list of the various wireless communication connecting methods include a wireless communication method using the wireless internet module 113, a wireless communication method using the short range communication module 114 and a wireless communication method using the mobile communication module 112. In this instance, the controller 180 may transmit and receive a signal to and from the first mobile terminal via the wireless internet module 113 preferentially, when the wireless communication with the first mobile terminal is enabled via the wireless internet module 113. In case the wireless communication with the first mobile terminal is not enabled via the wireless internet module 113, the wireless communication via the short range communication module 114 may be tried. In case even the wireless communication with the first mobile terminal via the short range communication module 114 is not enabled, the controller 180 may transmit and receive a signal to and from the first mobile terminal via the mobile communication module 112.

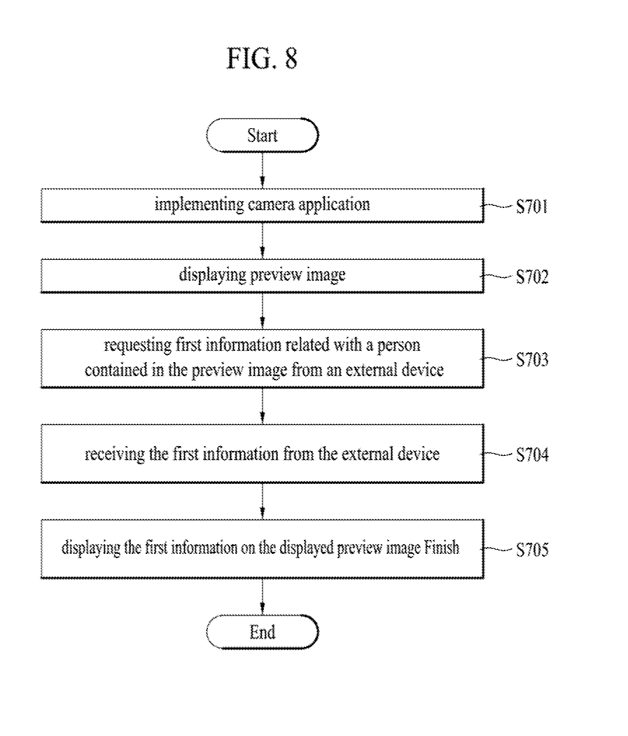

Hereinafter, referring to FIGS. 8 through 20, an embodiment will be described in a position of the first mobile terminal It is assumed that the configuration for sharing the information with the second mobile terminal is complete as mentioned above, referring to FIGS. 3, 4, 5, 6 and 7. Also, it is assumed that the first mobile terminal is in a state where the information sharing function is activated.

FIG. 8 is a flow chart illustrating an example of a method for sharing information between a first mobile terminal and a second mobile terminal according to one embodiment of the disclosure, in a position of the first mobile terminal

The controller 180 implements a camera application in accordance with a user command (S701).

The display 151 displays the preview image acquired by the camera 121 (S702).

The wireless communication unit 110 requests the information on the person contained in the preview image from the external device (he second mobile terminal). The information related with the person is referred to as the first information.

The external device requested the first information from may be the external device selected by the user based on the result of the searching for information sharable external devices or the external device specified based on the result of the face recognition on the person contained in the preview image.

The wireless communication unit 110 receives the first information from the external device (S704).

The display 151 displays the received information on the displayed preview image (S705).

FIG. 9 is a diagram illustrating an example of a screen displayed on a display of a mobile terminal according to one embodiment of the disclosure. The mobile terminal shown in FIG. 9 is corresponding to the first mobile terminal

Referring to FIGS. 9 (a), the display 151 displays the preview image 810 acquired by the camera 121.

The controller 180 searches for information sharable external devices (the second mobile terminal). The information sharable external device may include an external device in a state where the information sharing function is activated (see FIG. 3), an external device having a first external device as an information sharing object (see FIG. 4), an external device wireless-communicable with the first mobile terminal currently via a communication connecting method permitting the information sharing (see FIG. 7) and an external device having a history of the information sharing with the first mobile terminal before.

The display 151 displays a list 820 of the searched external devices. In one embodiment, the list 820 of the external devices may be overlaid on a preview image 810.

The list 820 of the external devices has the information sharable external devices. The external devices having model names of the external devices and the user's name and mobile phone number are listed to make the user of the mobile terminal 100 identify whose device each of the external devices is.

When the list 820 of the external devices includes two or more external devices, the user may select one of them.

Once the user selects a specific external device 821 from the list 820, the wireless communication unit 110 requests the first information from the specific external device 821. Generally, the specific external device 821 may be the second mobile terminal used by the person contained in the preview image 810 and the first information may be the information on the person contained in the preview image 810.

In one embodiment, in case a short range communication method (e.g., Bluetooth (BT)) is configurated when the specific external device 821 shares the information, paring with the specific external device 821 may be performed before a signal for requesting the first information is transmitted.

In one embodiment, while the first information is received in response with the request for the first information form the specific external device 821, a message 830 for noticing that the information is requested as shown in FIG. 9 (b) may be displayed on the display 151. The message 830 may be overlaid on the preview image 810.

Referring to FIG. 9 (c), the wireless communication unit 110 receives the first information from the specific external device 821 and the display 151 displays the received first information on the preview image 810. The received first information 840 may be overlaid on the preview image 810 displayed on the display 151.

The transmitting of the signal for requesting the first information to the specific external device 82 land the receiving of the signal containing the first information received from the specific external device 821 may be enabled in accordance with a connecting method preset in the specific external device 821.

The displayed first information 840 may be determined based on the contents of the sharing information preset in the specific external device 821. Examples of the contents may include an image 841, an emoticon 842, an E-mail address, a signature 844, location information 845 and a QR code 846.

The arrangement of the elements 841˜846 composing the contents of the displayed first information 840 may be determined in accordance with the configuration set by the user of the specific external device 821 or conditions preset by the controller 180 of the first mobile terminal 100.

The user may touch and drag a predetermined portion of a region corresponding to the first information 840 displayed on the display 151, to change a display location of the first information 840. The user may touch and drag predetermined two portions of the region corresponding to the first information 840 inward and outward, to adjust the display size of the first information 840.

When the user touches a photo button 850 displayed on the display 151, an image composed with the first information 840 is captured on the preview image 810 and stored in the memory.

Meanwhile, in a state where the first information 840 received from the specific external device 821 is displayed on the display 151, the user selects another external device on the list of the external devices and checks the information received from the other external devices, which will be described, referring to FIG. 10.

FIG. 10 is a diagram illustrating another example of a screen displayed on a display of a mobile terminal according to one embodiment of the disclosure.

Referring to FIG. 10 (a), the user may select another specified external device 822 in case of checking the information received from another specific external device, not the first information 840 received from the specific external device 821, in a state where the first information 840 received from the specified external device 821 is displayed on the preview image 810.

When the user selects a specific external device 822 on the list 820, the wireless communication unit 110 requests the first information from the specific external device 822. The specific external device 822 may be the second mobile terminal used by another person contained in the preview image 810. The first information may be the information on this person contained in the preview image 810.

In one embodiment, in case a short range communication method (e.g., Bluetooth (BT)) is configurated when the specific external device 822 shares the information, paring with the specific external device 822 may be performed before a signal for requesting the first information is transmitted.

In one embodiment, while the first information is received in response with the request for the first information form the specific external device 822, a message 830 for noticing that the information is requested as shown in FIG. 10 (b) may be displayed on the display 151. The message 830 may be overlaid on the preview image 810.

Referring to FIG. 10 (c), the wireless communication unit 110 receives the first information from the specific external device 821 and the display 151 displays the received first information on the preview image 810. In this instance, the first information 840 received from the specific external device 821 is removed from the display 151 and the first information 860 received from the specific external device 822 is displayed on the display 151. The received first information 860 may be overlaid on the preview image 810 displayed on the display 151.

The transmitting of the signal for requesting the first information to the specific external device 822 and the receiving of the signal containing the first information received from the specific external device 822 may be enabled in accordance with a connecting method preset in the specific external device 822.

The displayed first information 860 may be determined based on the contents of the sharing information preset in the specific external device 821. Examples of the contents may include an image 861, an emoticon 862 and a phone number 863.

The arrangement of the elements 861˜863 composing the contents of the displayed first information 860 may be determined in accordance with the configuration set by the user of the specific external device 822 or conditions preset by the controller 180 of the first mobile terminal 100.

The user may touch and drag a predetermined portion of a region corresponding to the first information 860 displayed on the display 151, to change a display location of the first information 860. The user may touch and drag predetermined two portions of the region corresponding to the first information 840 inward and outward, to adjust the display size of the first information 860.

When the user touches a photo button 850 displayed on the display 151, an image composed with the first information 860 is captured on the preview image 810 and stored in the memory.

Meanwhile, in the embodiments of the disclosure, face recognition for a person contained in the preview may be implemented and an external device requesting first information may be specified, which will be described, referring to FIGS. 11, 12 and 13.

FIG. 11 is a diagram illustrating an example of a screen displayed on a display of a mobile terminal according to another embodiment of the disclosure. The mobile terminal 100 shown in FIG. 11 is corresponding to a first mobile terminal

Referring to FIG. 11 (a), the display 151 may display a preview image acquired by the camera 121.

The controller 180 implements face recognition of a person contained in the preview image 910 and extracts information related with the recognized person from the memory 160. The information related with the recognized person is referred to as “second information”. Specifically, the controller 180 searches for an image containing the recognized person (in other words, containing the recognized face) stored in the memory 160 through a gallery application or phone book application, such that it can extract the information related with the searched image (or the second information) from the memory 160. The second information includes information needed for specifying an external device and information needed to request the first information from the external device. For instance, the information may be the recognized person's name and phone number and a model number of the external device.

The display 151 may display an indicator 911 corresponding to the recognized face on the preview image 910.

The controller 180 specifies an external device which will request the first information based on the second information. The first information means the information received from a specific external device as mentioned above and the information on the person contained in the preview image.

Referring to FIG. 11 (b), the controller 180 notices the result of the face recognition to the user and controls the display 151 to display a graphic user interface 920 for receiving a user command configured whether to request the first information from the specified external device. When noticing the result of the face recognition through the graphic user interface 920 to the user, names registered in the contact application may be used in noticing the result of the face recognition to make it easy for the user to recognize the specified external device.

When the user selects a confirmation button 921 in the graphic user interface 920, the wireless communication unit 110 requests the first information from the specified external device. In this instance, the controller 180 preferentially confirms whether the specified external device is information-sharable or whether the specified external device is communicable.

Although not shown in the drawings, a message for noticing that the information is requested may be displayed on the display 151 while the first information is being received after a request for the first information is made to the specified external device.

Referring to FIG. 11 (c), the wireless communication unit 110 receives the first information from the specified external device 821 and displays the received first information 930 on the preview image 910. The received first information 930 may be overlaid on the preview image 910 displayed on the display 151.

The transmitting of the signal for requesting the first information to the specific external device and the receiving of the signal containing the first information received from the specific external device may be enabled in accordance with a connecting method preset in the specific external device.

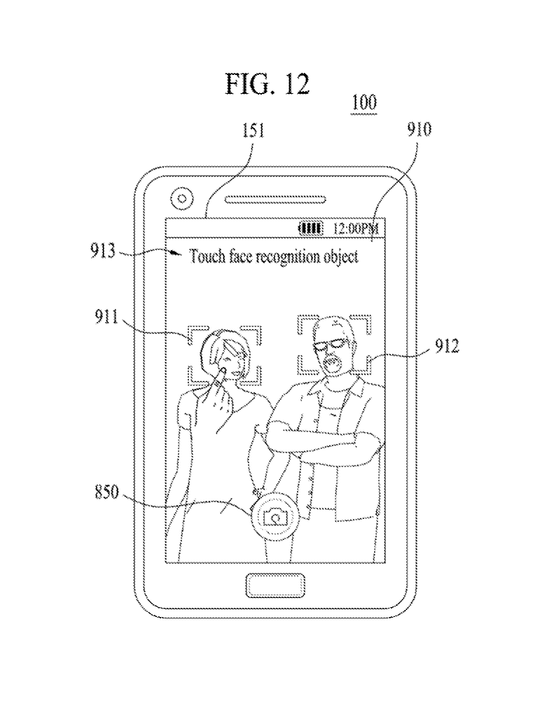

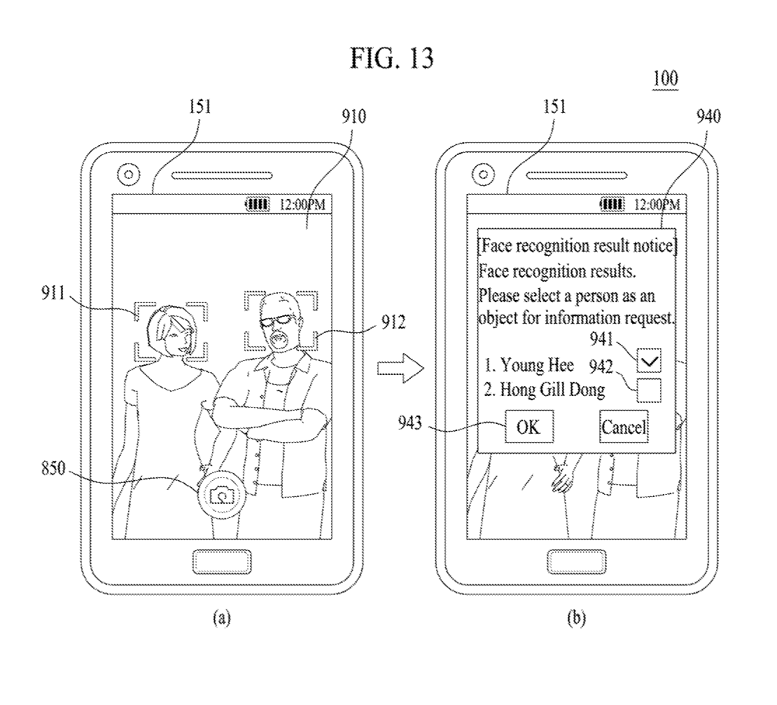

Meanwhile, when there are two or more recognized faces contained in the preview image, the external device may be specified based on the user's selection, which will be described as follows, referring to FIGS. 12 and 13.

FIG. 12 is a diagram illustrating an example of a screen displayed on a display of a mobile terminal according to one embodiment of the disclosure.

The display 151 displays the preview image 910 acquired by the camera 121 and the controller 180 implements face recognition for a person contained in the preview image 910. The display 151 may display an indicator 911 and 912 corresponding to the recognized face on the preview image 910.

When there are two or more faces recognized based on the result of the face recognition, the controller 180 may control a user input unit 130 to receive a selection command for selecting one of the two or more faces.

The controller 180 may recognize that the selection command is received, when a touch signal generated by touching of a screen region corresponding to one of the indicators 911 and 912 is input via the user input unit 130.

The display 151 may display a message for guiding the user's selection.

When the user touches a screen region corresponding to one indicator 911 or 912, a process shown in FIGS. 11 (b) and (c) may be implemented. The process shown in FIGS. 11 (b) and (c) is equal to the process mentioned, referring to FIG. 11, and it will be omitted.

FIG. 13 is a diagram illustrating another example of a screen on a display of a mobile terminal according to one embodiment of the disclosure.

Referring to FIG. 13 (a), the display 151 displays a preview image 910 acquired by the camera 121 and the controller 180 implements face recognition for a person contained in the preview image 910. The display 151 may display an indicator 911 and 912 corresponding to the recognized face on the preview image 910.

When there are two or more faces recognized based on the result of the face recognition, the controller 180 may control a user input unit 130 to receive a selection command for selecting one of the two or more faces. In other words, the controller 180 controls the display 151 to display the graphic user interface 940 for receiving a selection command configured to select one of the two or more faces.

The graphic user interface 940 may be configured of the names registered in the phone book application to make it easy for the user to recognize the result of the face recognition.

The user touches a check box 941 corresponding to a specified external device from which the first information will be requested out of check boxes 941 and 942 in the graphic user interface 940 and selects a confirmation button 943.

Once the user selects the confirmation button 943, the first information is requested from one selected specific external device through the graphic user interface and the process shown in FIG. 11 (c) may be performed. The process shown in FIG. 11 (c) is equal to the process mentioned above, referring to FIG. 11, and it will be omitted.

Meanwhile, according to the embodiments of the disclosure, the first information transmitted from the external device (or the second mobile terminal) may be edited by the user, which will be described as follows, referring to FIG. 14.

FIG. 14 is a diagram to describe an example of a method for editing first information displayed on a display of a mobile terminal according to one embodiment of the disclosure.

Referring to FIG. 14 (a), the display 151 displays the preview image 1010 acquired by the camera 121 and the first information 1020 received from a specified external device. The first information 1020 is overlaid on the preview image 1010.

The user touches an edit button 1030 for editing the first information 1020 and edits the first information 1020. The editing of the first information 1020 may be performed by configurating the display size of the first information 1020 or partial selecting of the first information 1020. The editing (e.g., changing the location or size of the first information displaying may be performed, even without entering a specific editing step through the edit button 1030.

When the user selects the edit button 1030, an information edit screen 1100 shown in FIG. 14 (b) may be displayed on the display 151.

For instance, the information edit screen 1100 may include a first menu for re-arranging elements corresponding an image, a signature, a QR code, an emoticon, an address, an E-mail address, a phone number, location information, sound contained in the first information 1020; a second menu 1120 for editing decorations such as giving a visual effect to the first information or changing a style of text data contained in the first information 1020; and a third menu 1130 for select to delete some of the first information 1020. Rather than those menus, diverse editing menus may be provided in the information edit screen 1100.

Once selecting the first menu 1110, the second menu 1120 or the third menu 1130, the user may enter a specific edit screen of each menu.

When the user touches an EXIT button 1140 after completing the editing of the first information, the controller 180 may control the display 151 to display the edited first information 1020.

Meanwhile, in the embodiments of the disclosure, if it is difficult to receive the first information from the external device, the information stored in the memory 160 can be used instead of the information received from the external device, which will be described, referring to FIGS. 15 through 20 as follows.

FIG. 15 is a flow chart to describe an example of a method for using the information stored in a memory, instead of the information received by a mobile terminal according to one embodiment of the disclosure from an external device.

The controller 180 implements a camera application in accordance with a user command and activates the camera 121 (S1201).

The display 151 displays a preview image acquired by the camera 121 (S1202).

The controller 180 implements face recognition for a person contained in the preview image (S1203).

The controller 180 extracts the information related with the recognized person from the memory 160. In this embodiment, the information related with the recognized person is referred to as “third information”.

The display 151 displays the extracted third information on the displayed preview image (S1205).

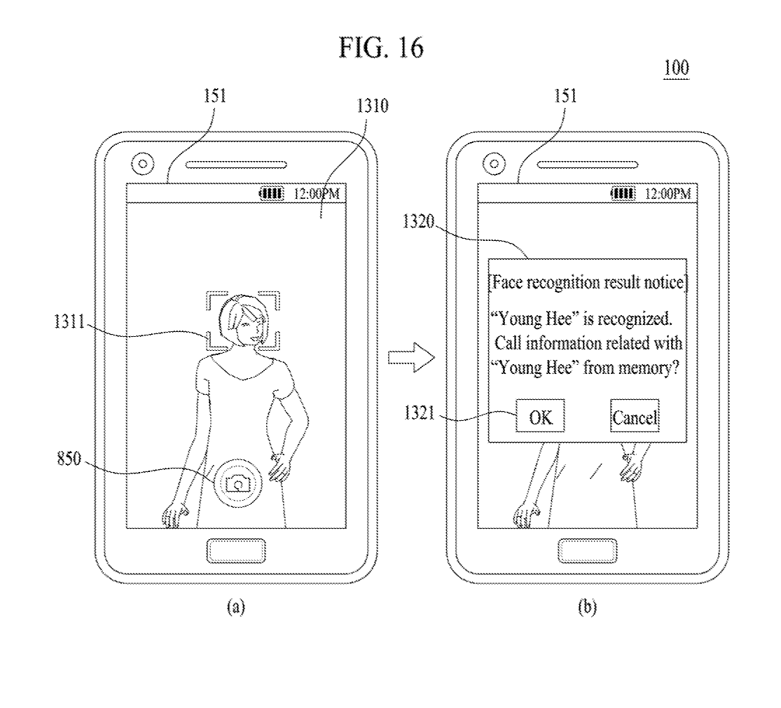

FIGS. 16, 17, 18, 19 and 20 are diagrams illustrating examples of a screen displayed on a display of a mobile terminal according to one embodiment of the disclosure.

Referring to FIG. 16 (a), the display 151 displays a preview image 1310 acquired by the camera 121.

The controller 180 implements face recognition for a person contained in the preview image 1310 and extracts information related with the recognized face (the third information) from the memory 160. Specifically, the controller 180 may search for an image containing the recognized face in a gallery application phone book application in the memory 160 and extract the information related with searched image (the third information) from the memory 160. If necessary, the controller 180 may extract the third information from a history of existing information sharing stored in the memory 160. The third information may be a photograph containing the recognized person, the recognized person's name, address, phone number and E-mail address.

The display 151 may display an indicator 1311 corresponding to the recognized face on the preview image 1310.

Referring to FIG. 16 (b), the controller 180 notices the result of the face recognition to the user and controls the display 151 to display a graphic user interface 1320 for receiving a user command configured to call the information related with the recognized face. When the result of the face recognition is noticed to the user through the graphic user interface 1320, the names registered in the phone book application is used in noticing the result of the face recognition.

For instance, the controller 180 may search for an image containing the recognized face in the gallery application or phone book application as the information needed to configurate the graphic user interface 1320. The controller 180 may extract the recognized person's name from the memory 160 out of the information related with the searched image. When the user selects a confirmation button 1321 in the graphic user interface 1320, the other information may be extracted from the memory 160, except the recognized person's name out of the information related with the searched image.

A face recognition process shown in FIG. 16 may be performed, in case communication connection is not performed smoothly as the request for the first information from a specified external device is made as mentioned above, referring to FIGS. 8 through 13 or the first information failed to be received from the specified external device, or in case the information sharing function of the mobile terminal 100 (the first mobile terminal) is not activated.

Meanwhile, in case there are two or more recognized faces based on the result of the recognition, the controller 180 controls the user input unit 130 to receive a selection command for selecting one of the two or more recognized faces, which will be similar to the description shown in FIGS. 12 and 13 and detailed description thereof will be omitted.

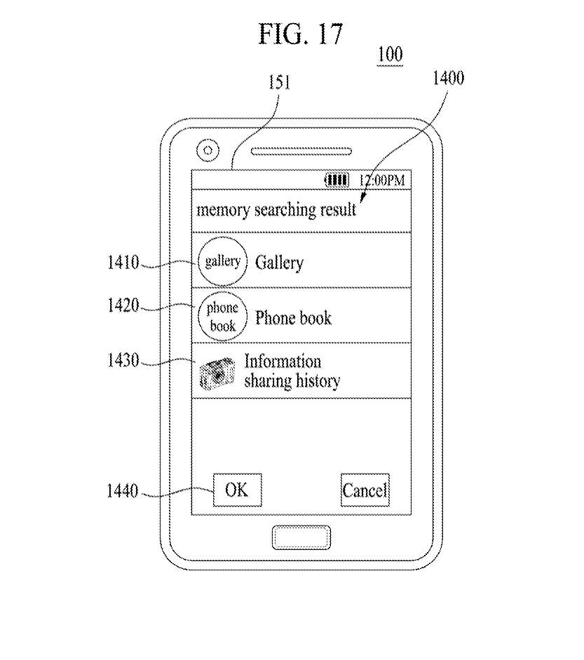

When the user selects a confirmation button 1321 in the graphic user interface 1320, a memory search result screen 1400 shown in FIG. 17 may be displayed on the display 151.

For instance, the memory search screen 1400 may include a first menu 1410 for displaying the result of the searching of the gallery application in the memory 160; a second menu 1420 for displaying the result of the searching of the phone book application in the memory 160; and a third menu 1430 for displaying the result of the information sharing history in the memory 160. The third menu 1430 may be activated when there is a history the first information receiving from the external device (the second mobile terminal) possessed by the recognized person.

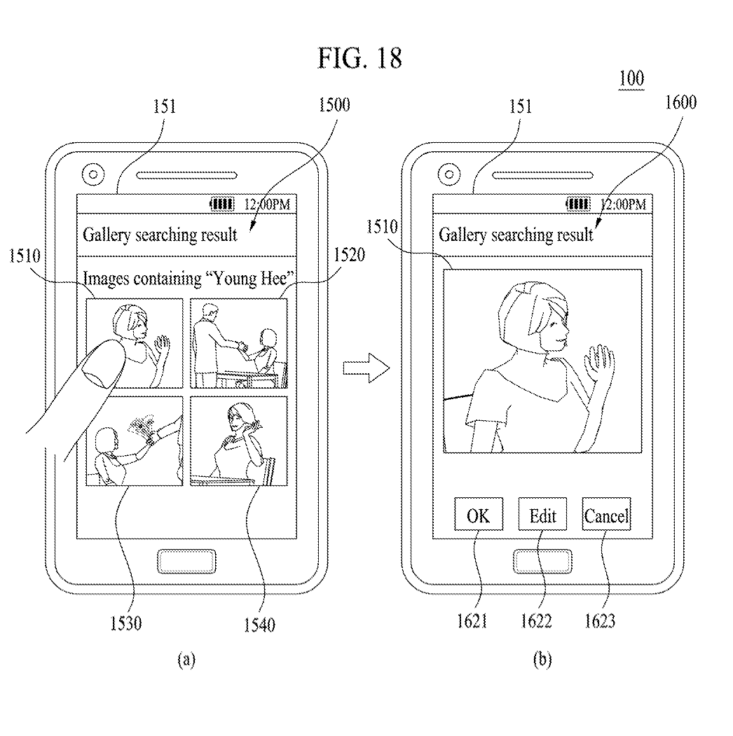

When the user selects the first menu 1410, the gallery searching result screen 1500 may be displayed on the display 151 as shown in FIG. 18 (a).

Images 1510˜1540 containing the recognized person may be arranged on a gallery searching result screen 1410. When the user touches one image 1510 of the images 1510˜4540 in the gallery searching result screen 1500, a gallery searching result screen 1600 shown in FIG. 18 (b) may be displayed on the display 151.

The selected image 1510 is enlarged and displayed on the gallery searching result screen 1600 shown in FIG. 18 (b).

When the user selects a confirmation button 1621 in the gallery searching result screen 1600, the image 1510 may be selected as the third information which will be displayed on the preview image 1310.

When the user selects an edit button 1622 in the gallery searching result screen 1600, the image 1510 may be edited, using a series of photo editing functions provided by the gallery application.

When the user selects a cancel button 1623 in the gallery searching result screen 1600, the screen may return to the gallery searching result screen 1500 shown in FIG. 18 (a).

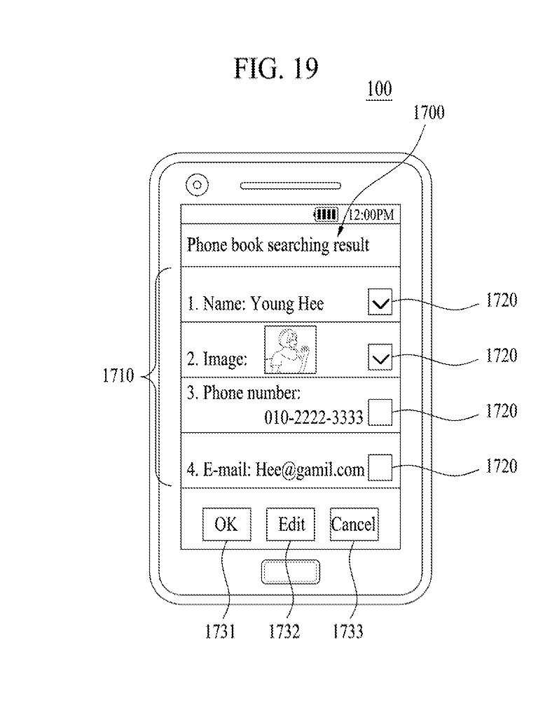

When the user selects the second menu 1420 from a memory searching result screen 1400 shown in FIG. 17, a phone book search result screen 1700 shown in FIG. 19 may be displayed on the display 151.

In the phone book searching result screen 1700 shown in FIG. 19 may be arranged the information 1710 registered in the phone book application related with the recognized face. The user may touch a check box 1720 corresponding to the information which will be contained in the third information displayed on the preview image 1310 and select a confirmation button 1731.

When selecting an edit button 1732 in the phone book searching result screen 1700, the user may edit the checked box 1720. When selecting a cancel button 1733, the user may return to a memory searching result screen 1400 shown in FIG. 17.

Referring to FIG. 17, once selection and editing of the third information which will be displayed on the preview image 1310 is complete, the user may select a confirmation button 1440.

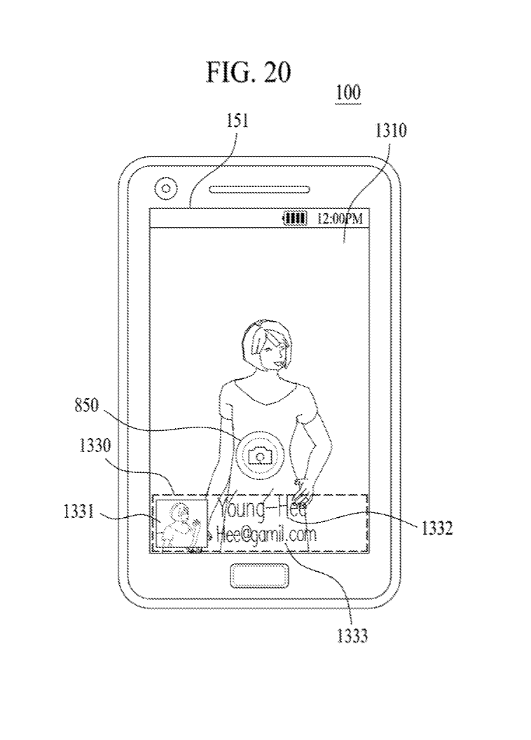

Once the user selects the confirmation button 1440, a screen shown in FIG. 20 may be displayed on the display 151.

Referring to FIG. 20, the display 151 may display the preview image 1310 acquired by the camera 121 and the third information 1330 extracted from the memory 160. The third information 1330 may be overlaid on the preview image 1310.

The third information 1330 may be the information selected and edited by the user as mentioned above, referring to FIGS. 17 through 19. The third information 1330 may be related with at least one of a name, a signature, and address, an E-mail address, an image, an emoticon, a QR code, location information of an external device or sound. For instance, the third information 1330 may be related with an image 1331, a name 1332 and an E-mail address 1333

When the user touches a photo button 850 displayed on the display 151, an image generated by composing the third information 1330 with the preview image 1310 may be captured and stored.

It is described so far that the image displayed on the display 151 is the preview image. Even when the image stored in the memory 160 after acquired by the user's photo command, the examples of information sharing with the external device and examples of the usage of the image information extracted from the memory 160 may be applicable.

Advantages of the mobile terminal and the controlling method of the same according to the embodiments of the disclosure will be as follows.

The mobile terminal according to one embodiment of the disclosure may provide the fun function through the communication between the person capturing the photograph and the person who is the object of the photographing.

Furthermore, the mobile terminal according to one embodiment of the disclosure may provide the solution capable of composing the person-related information received from the external device with the mage acquired by the camera.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

It will be apparent to those skilled in the art that the present invention can be specified into other form(s) without departing from the spirit or scope of the inventions.

The above-described methods can be implemented in a program recorded medium as computer-readable codes. The computer-readable media include all kinds of recording devices in which data readable by a computer system are stored. The computer-readable media include ROM, RAM, CD-ROM, magnetic tapes, floppy discs, optical data storage devices, and the like for example and also include carrier-wave type implementations (e.g., transmission via Internet). And, the computer can include the control unit 180 of the terminal

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for controlling a mobile terminal comprising:
displaying a preview image captured via a camera of the mobile terminal;
requesting first information associated with a person displayed in the preview image from an external device;
receiving the first information from the external device; and
displaying the first information on the displayed preview image.

2. The method of claim 1, wherein the received first information is overlaid on the displayed preview image.

3. The method of claim 1, further comprising:
performing face recognition using the captured preview image to identify the person displayed in the preview image; and
specifying the external device using second information of the external device associated with the identified person.

4. The method of claim 3, further comprising selecting a face of one or more faces recognized by performing the face recognition and identifying the person of the selected face.

5. The method of claim 3, further comprising displaying a graphic user interface for receiving a user input to request the first information from the specified external device.

6. The method of claim 1, further comprising searching for external devices and displaying a list of discovered external devices resulting from the search, wherein the first information is requested from an external device selected from the displayed list of discovered external devices.

7. The method of claim 1, further comprising editing the received first information, wherein the edited first information is displayed on the displayed preview image.

8. The method of claim 7, wherein editing the received first information comprises at least:
rearranging elements contained in the received first information;
configuring a display size of the received first information; or
selecting a portion of the received first information.

9. The method of claim 1, wherein the first information comprises at least:
a name;
a signature;
an address;
an E-mail address;
a phone number;
an image;
an emoticon;
a Quick Response code;
location information of the external device; or
an audio file.

10. A method for controlling a mobile terminal comprising:
displaying a preview image captured via a camera;
performing face recognition using the preview image to identify a person included in the captured preview image;
retrieving information associated with the person from a memory; and
displaying the retrieved information with the displayed preview image.

11. The method of claim 10, wherein the retrieved information is overlaid on the displayed preview image.

12. The method of claim 10, wherein retrieving the information comprises:
searching the memory for an image including the recognized face; and
retrieving the information related with the image from the memory.

13. The method of claim 12, the searching the memory comprises:
searching for an image including the recognized face in a phone book application stored in the memory; or
searching for an image including the recognized face in a gallery application stored in the memory.

14. The method of claim 10, wherein performing face recognition comprises selecting a face from a plurality of recognized faces and identifying the person using the selected face.

15. The method of claim 10, further comprising:
editing the retrieved information; and
displaying the edited information on the displayed preview image.

16. The method of claim 15, wherein editing the retrieved information comprises at least:
rearranging elements included in the retrieved information;
configuring a display size of the retrieved information; or
selecting a portion of the retrieved information to display.

17. The method of claim 10, wherein the retrieved information comprises at least:
a name;
a signature;
an address;
an E-mail address;
a phone number;
an image;
an emoticon;
a QR code;
location information of the external device; or
an audio file.

18. A mobile terminal comprising:
a camera;
a display;
a wireless communication unit; and
a controller configured to:
cause the display to display a preview image captured by the camera;
request first information from an external device via the wireless communication unit wherein the first information is related to displayed information included in the preview image;
receive the first information from the external device via the wireless communication unit; and
cause the display to display the received first information on the displayed preview image.

19. The mobile terminal of claim 18, wherein the displayed information comprises a face of a person, and the controller is further configured to:
perform face recognition using the preview image to identify the person associated with the face; and
specify the external device using second information of the external device associated with the identified person.

20. The mobile terminal of claim 19, wherein the controller is further configured to search for external devices and cause the display to display a list of discovered external devices resulting from the search, wherein the first information is requested from an external device selected from the displayed list of discovered external devices.
